(19) United States
(12) Patent Application Publication
(10) Pub. No.: US 2012/0323659 A1
(43) Pub. Date: Dec. 20, 2012

(54) METHODS AND SYSTEM FOR AUTOMATING ONLINE SOCIAL NETWORK ENGAGEMENTS FOR E-COMMERCE APPLICATIONS

(76) Inventors: Kiran Kumar Konduru, Bangalore (IN); Premjith Goplalakrishna Pillai, Hyderabad (IN)

(21) Appl. No.: 13/296,802

(22) Filed: Nov. 15, 2011

(30) Foreign Application Priority Data
Jun. 15, 2011 (IN) 1744/MUM/2011

(51) Int. Cl. G06Q 30/02

(52) U.S. Cl. 705/14.23; 705/26.1

(57) ABSTRACT

The present invention relates generally to internet based e-commerce and more particularly to connecting an electronic commerce application and an online social network. The methods and system described herein enables members of one or more online social network to get offers from an e-commerce application. The databases of online social network(s) can be accessible in conjunction with the e-commerce application. The members of one or more online social network get rewarded with incentives upon successful interaction with an interactive content provided by the e-commerce application.

### CROSS-REFERENCE TO RELATED APPLICATION

The present application claims priority under 35 U.S.C. 119(a) to India (IN) patent application number 1744/MUM/2011 filed Jun. 15, 2011, which IN patent application is incorporated herein by reference in its entirety.

### BACKGROUND OF THE INVENTION

1. Field of the Invention

The present invention relates generally to internet based electronic commerce (e-commerce) and more particularly to connecting an electronic commerce application and an online social network.

2. Description of the Prior Art

Internet selling of virtual and real goods have been traditionally done by online retailers via electronic commerce (e-commerce) website. Ecommerce applications use various means of advertising to promote their goods and services. Passive promotions and messages like banner advertisements, link advertisement, video advertisements, do not engage the consumers. Effects of passive advertisements are limited, also the consumer may not promote the product or the advertisement

In the recent years applications available on the internet facilitate social networking. Online social networks enables messages and information to spread rapidly and successfully to a large audience in a short time, also called as viral spreading of messages. Viral spreading is a very lucrative proposition for advertising and promoting goods and services.

Online retails have attempted to utilize social networking applications and online social networks to promote goods and services. For example, messages about goods purchased on an ecommerce site can be shown on the social networking site. Users of the social networking site can see the product purchase and can interact with the message. The interaction with the message may include liking the message, commenting about the message, and adding the message to a wish list. All the available forms of interaction are passive interaction.

However, the interaction with a message from an e-commerce application on a social networking site does not necessarily ensure that the users of online social network will visit the e-commerce application or make purchases from the e-commerce application. Hence, there is a requirement for generating interactive content for e-commerce application on online social networks that provides user engagement. There is also a requirement for methods and systems that will enable e-commerce applications to attract with users from an online social network.

Although present systems and methods are functional, they may not be sufficiently accurate or otherwise satisfactory. Therefore there exists a need for a system, and methods for generating automatic online social network engagement for e-commerce applications. In this regard, the present invention substantially fulfills this need. In this respect, the methods and system for generating automatic online social network engagement for e-commerce applications according to the present invention substantially departs from the conventional concepts and designs of the prior art, and in doing so provides an apparatus primarily developed for the generating automatic online social network engagement for e-commerce applications.

There is therefore a need for a method and system which connecting an electronic commerce application and an online social network.

### SUMMARY OF THE INVENTION

In view of the foregoing disadvantages inherent in connecting the online social networks with electronic commerce application present in the prior art, the present invention provides an improved system and methods for generating automatic online social network engagement for e-commerce applications, and overcomes the above-mentioned disadvantages and drawbacks of the prior art. As such, the general purpose of the present invention, which will be described subsequently in greater detail, is to provide a new and improved system for generating automatic online social network engagement for e-commerce applications and method which has all the advantages of the prior art mentioned heretofore and many novel features that result in generating automatic online social network engagement for e-commerce applications which is not anticipated, rendered obvious, suggested, or even implied by the prior art, either alone or in any combination thereof.

In one embodiment of the present invention a system is provided. The system includes at least one e-commerce server, at least one social network server, and an interactive content server. The interactive content server is capable of collecting data from the e-commerce server, creating at least one interactive content using the collected data, and sending the interactive content to the social network server.

In another embodiment of the present invention a method is provided. The method includes collecting data about goods purchased from an electronic commerce application, creating at least one interactive content based on the data about goods purchased, publishing at least one interactive content on an online social network, rewarding a user with redeemable incentives when the user successfully interacts with the interactive content on the online social network, and redeeming the redeemable incentives when the user purchases goods from the e-commerce application.

In another embodiment of the present invention a method is provided. The method includes providing an e-commerce server, an interactive content server and a social network server. The method further includes collecting data about goods purchased from an electronic commerce application hosted on the e-commerce server, creating at least one interactive content based on the data about goods purchased using a computer executable algorithm on the interactive content server, publishing at least one interactive content on an online social network hosted on the social network server, rewarding a user with redeemable incentives when the user successfully interacts with the interactive content on the online social network, and redeeming the redeemable incentives when the user purchases goods from the e-commerce application.

These together with other objects of the invention, along with the various features of novelty that characterize the invention, are pointed out with particularity in the claims annexed to and forming a part of this disclosure. For a better understanding of the invention, its operating advantages and the specific objects attained by its uses, reference should be made to the accompanying drawings and descriptive matter in which there are illustrated preferred embodiments of the invention.

There has thus been outlined, rather broadly, the more important features of the invention in order that the detailed description thereof that follows may be better understood and in order that the present contribution to the art may be better appreciated.

Numerous objects, features and advantages of the present invention will be readily apparent to those of ordinary skill in the art upon a reading of the following detailed description of presently preferred, but nonetheless illustrative, embodiments of the present invention when taken in conjunction with the accompanying drawings. In this respect, before explaining the current embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of descriptions and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

The details of one or more implementations are set forth in the accompanying drawings and the description below. Other features will be apparent from the description and drawings, and from the claims.

### BRIEF DESCRIPTION OF THE DRAWINGS

The invention will be better understood and objects other than those set forth above will become apparent when consideration is given to the following detailed description thereof. Such description makes reference to the annexed drawings wherein:

FIG. 1 is a block diagram of a system according to an embodiment of the present invention.

FIG. 2 is a flow chart of a method according to an embodiment of the present invention.

### DETAILED DESCRIPTION OF THE INVENTION

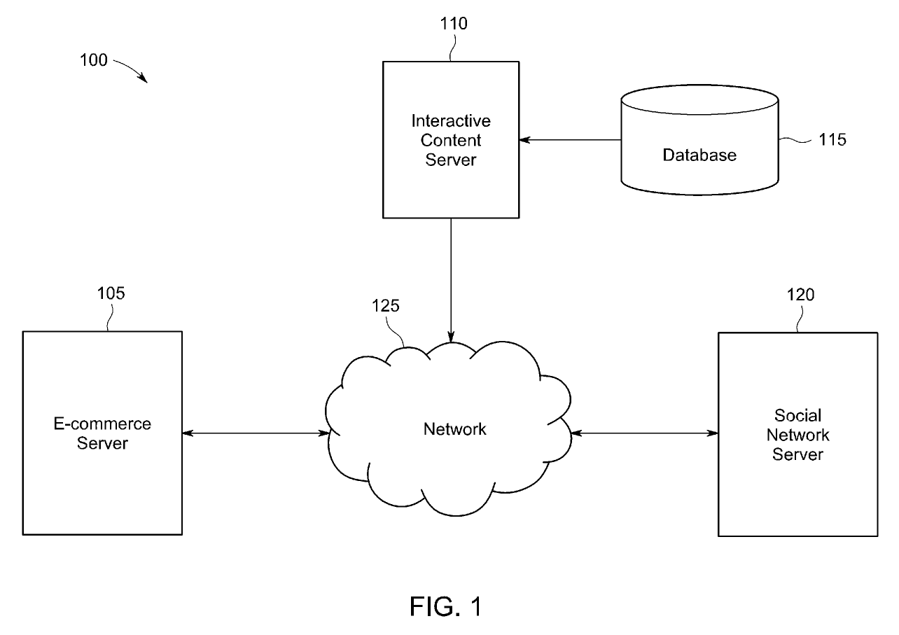

FIG. 1 is a block diagram of a system 100 according to an embodiment of the present invention. In accordance with an embodiment of the present invention the system 100 may include at least one e-commerce server 105, at least one interactive content server 110, at least one social network server 120, at least one database 115 and a network 125. Each block is described in further detail below.

The block diagram is shown containing only representative systems for illustration. However, real-world environments may contain more or fewer or different systems or components or blocks, both in number and type, depending on the purpose for which the environment is designed, as will be apparent to one skilled in the relevant arts. For example, though the e-commerce server 105 is shown connected to network 130, it may be a part of the mobile telephone network 110. Similarly, only a single database 115 is shown, though many such databases may be present. Similarly, only a single interactive content server 110 and social network server 120 is shown, though many such additional servers may be present.

The network 125 may be a network of computers and communication devices that provides connectivity between the constituents of the network. The worldwide network of computers commonly referred to, as the Internet is an example of such a network. The network 125 may also contain communication devices such as mobile phones, PDA's, etc. (referred to as internet enabled mobile phones) which are part of mobile telephony networks, and are enabled to connect to the Internet over the mobile telephony networks. The users of the internet enabled mobile phones access information from computers, servers, etc. over the Internet using web browsers such as Internet Explorer, Firefox, Opera, Google Chrome, Safari, etc. Information presented in a web browser is generally referred to as a web page. Additionally, users can access content through mobile applications (e.g., iPhone applications or android applications).

The e-commerce server 105 may be a computer program running as a service, to serve the needs or requests of other programs, which may or may not be running on the same computer. The e-commerce server 105 executes various applications, which may be accessed from a computer, a mobile phone, or a wireless internet enabled device using a suitable user interface. For example, e-commerce server 105 may generate various web pages or content, which are sent over network 125, and a user may interact with the content through a web browser implemented on an internet enabled device or app (application) downloaded or installed on the internet enabled device. The e-commerce server 105 may be capable of storing, collecting, and retrieving information about goods available for sale. The e-commerce server 105 may also be capable of collecting information about purchased goods when a user purchases goods via above-mentioned means.

The social network server 120 may assemble with the one or more online social network running on a computer or may be running over a remote network. The social network server 120 may be a computer program running as a service, to serve the needs or requests of other programs, which may or may not be running on the same computer. The social network server 120 executes various applications, which may be accessed from a computer, a mobile phone, or a wireless internet enabled device using a suitable user interface. For example, social network server 120 may generate various web pages or content, which are sent over network 125, and a user may interact with the content through a web browser implemented on an internet enabled device or app (application) downloaded or installed on the internet enabled device. The social network server 120 is capable of collecting information about the members who are tied by one or more specific types of interdependency, such as friendship, common interest, financial exchanges, dislike, relationships, beliefs, and knowledge. The social network server 120 also aggregates updates that have a consolidated stream of information on all recent activities on the one or more online social network. The recent activities may include invite friend features, newsfeeds, minifeeds, other features that display online activities of users and people in a members' online social network, notifications, requests, other social networking features that enable messages to be delivered to members of the one or more online social networks, and an indication of a member's selected applications on the member's social networking profile page.

The interactive content server 110 may run on the e-commerce server 105 or social network server 120 or running from a remote place over a network. The interactive content server 110 may collect data from e-commerce server 105 and social network server 115. The interactive content server 110 may also collect data from database 120. The database 120 may include encyclopedia, recent news, prices of goods, etc. Data collected from the e-commerce server 105 by the interactive content server 110 may be data about purchased goods. The data about purchased goods may include one or more of an identification code of the goods, name of the goods, description of the goods, Price of the goods, type/category of the goods (e.g.; movie, books, software, e-book, hardware, etc.), and other information (Name of Author, ISBN Code, EAN Code) depending on the type of the purchased goods.

The interactive content server 110 creates an interactive content based on information of the purchased goods. The interactive content may include for example: sweepstakes, contests, instant win games, participant-generated content contests including contests where the general public votes to determine the winner or winners, quizzes, games, coupons, and vouchers.

The interactive content server 110 may generate interactive content based on the purchased goods information in combination with data accessed on database 115. The generation of interactive content may be done using a computer executable algorithm. The algorithm may extract the purchased goods information, create an interactive content, and forward it to the social network server 115 via an Application Programming Interface (API) over a network 125. An Application Programming Interface (API) is a particular set of rules and specifications that software programs can follow to communicate with each other. It serves as an interface between different software programs and facilitates their interaction; similar to the way the user interface facilitates interaction between users and computers.

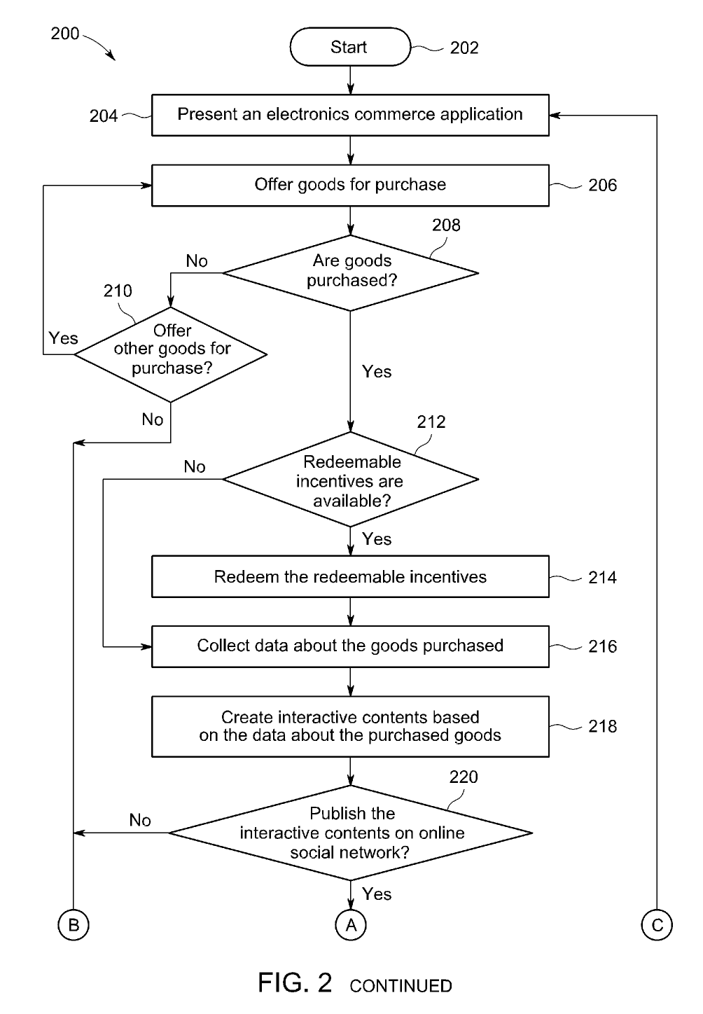

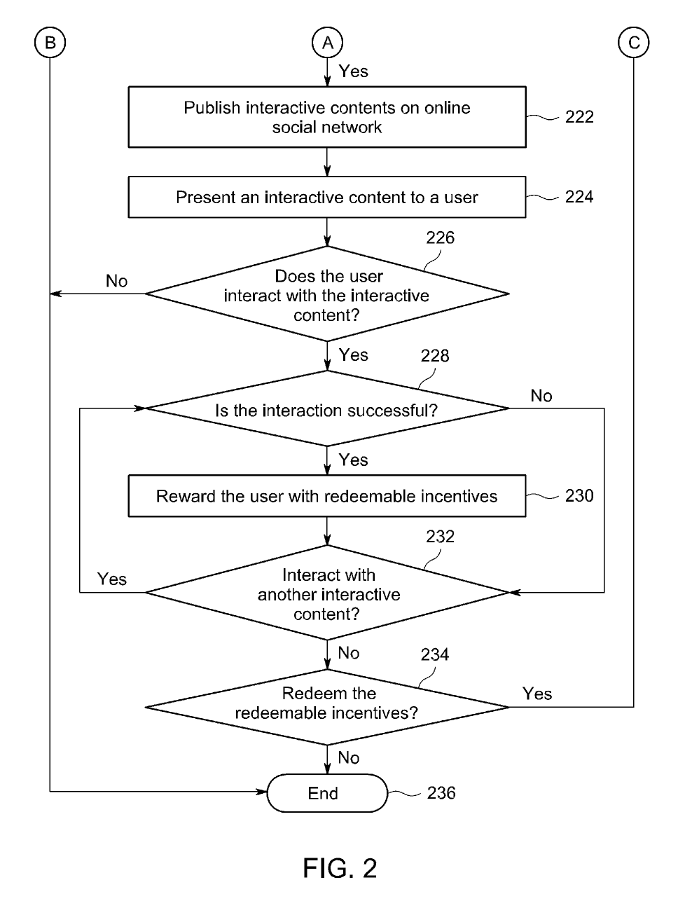

FIG. 2 is a flow chart of a method 200 according to an embodiment of the present invention. The flowchart is described with respect to FIG. 1, merely for illustration. However, various features can be implemented in other environments and other components. Furthermore, the steps are described in a specific sequence merely for illustration.

Alternative embodiments in other environments, using other components and different sequence of steps can also be implemented without departing from the scope and spirit of several aspects of the present invention, as will be apparent to one skilled in the relevant arts by reading the disclosure provided herein. The flowchart starts in step 202, in which control passes immediately to step 204.

In step 204, e-commerce server 105 receives a request for an electronic commerce (e-commerce) application. The request may be by a user, via a computer terminal, a mobile phone, or an internet enabled device. An e-commerce application may be a website hosted on the e-commerce server 105, a program capable of connecting to the e-commerce server 105, a mobile phone application, a browser application, a browser plugin, or a browser extension. The request for the e-commerce application may be made using protocols such as an http protocol, and other protocols well known in the arts. Upon receiving the request the e-commerce server may present the e-commerce application. After the e-commerce application is presented the control passes to step 206.

In step 206, goods available for purchase are presented via the e-commerce application. Prior to accessing goods available for purchase, the e-commerce application may require an account creation. The account may be created on the e-commerce application. Alternately, if an account already exists then authentication may be required before goods for purchase are presented. Transmitting account information to the e-commerce server 105, preferably through the e-commerce application, may do the authentication. Account authentication may also be done via third party authentication applications like OpenID, Google Accounts, etc. The account information may include, for example: the user name, a password, a billing address, and billing information, such as a credit card number or billing authorization information. The process passes control to step 208.

In step 208, the process checks if any goods have been purchased. If no goods are purchased, other goods are offered for purchase (step 210 and step 206). If there are no good to be offered then the process ends (step 236). The goods for purchase may be shown on the e-commerce application based on their category, price range, shipping charge, type, availability, and/or search criteria given in a search interface made available on the e-commerce application. Steps needed to complete a purchase may include selecting the goods and entering it into a virtual cart, providing shipping details, and making a payment. The payment may be made using online payment methods well known in the relevant arts. If a purchase is made the control passes to step 212.

In step 212, the process checks if there are any redeemable incentives available for redeeming. The redeemable incentives may include points, virtual cash, or coupons. The redeemable incentives may be redeemed in exchange for one or more of a discount on the price of the product purchased, a waiver of shipping fees, a free gift, a shopping voucher, a coupon, an incentive for a gift in the future, an offer for a discount on a second purchase and an offer for tickets to events. If redeemable incentives are available, they are redeemed and the control is passed to step 216. If redeemable incentives are not available then the process passes control to step 216.

In step 216, data about the goods purchased is collected. The data may be collected via an application-programming interface (API), a computer executable algorithm by the interactive content server 110. The data collected may include one or more of an identification code of the goods, name of the goods, description of the goods, Price of the goods, type/category of the goods (e.g.; movie, books, software, e-book, hardware, etc.), and other information (Name of Author, ISBN Code, EAN Code) depending on the type of the purchased goods. After the data is collected control passes to step 218.

In step 218, the interactive content server 110, generates interactive content based on the data about purchased goods as described above. The interactive content server may combine the data about goods purchased with data from database 115 to generate the interactive content. The interactive content may include sweepstakes, contests, instant win games, participant-generated content contests including contests where the general public votes to determine the winner or winners, quizzes, games, coupons, and vouchers. After the interactive content is generated the control passes to step 220.

In step 220, permission is taken for publishing an interactive content on an online social network. Permission may be taken from a user, the social network server 120, and/or the e-commerce server 105. Permission may be automatically granted based on an authentication requirement. The interactive content may be distributed through applications within the online social networks or services that enable other applications to access the profile information of members of one or more online social network. The interactive content may be presented with clickable button. If permission to publish the interactive content is denied the process ends (step 236). If the permission to publish the interactive content is granted the control passes to step 222, and the interactive content is published to an online social network. The control passes to step 224.

In step 224, the interactive content is presented to a user of the online social network. The interactive content may be presented to the user by means of a webpage, email, flash page, downloadable file, document file, and/or other methods of presenting information via a network well known in the relevant arts. The user may receive, view, and interact with the interactive content using a network connected computer, a mobile phone, an internet enabled mobile phone, and/or an internet enabled wireless device. After the user is presented the interactive content, the control passes to step 226.

In step 226, the interactive content server 110 may ensure whether the interaction was successful or not. The success of interaction with the interactive content may vary based on the type of the interactive content. Successful interaction may include answering questions correctly, completing a quiz, playing a game successfully, completing a puzzle, and guessing a price of a product. If the interaction was successful then the control is passed to step 230. In step 230, the user is rewarded with redeemable incentives. The redeemable incentives may include points, virtual cash or coupons. The control passes to step 232 after rewarding redeemable incentives. If the interaction as assessed in step 226 by the interactive content server 110 is not successful, the control is passed to step 232.

In step, 232 the user is given another opportunity to interact with an interactive content. If the user chooses not to interact with the interactive content, the control passes to step 234. In step 234, the user may be requested to redeem the redeemable incentives earned by successful interaction with the interactive content. If the user chooses to redeem the redeemable incentives, the control goes back to step 204. If the user chooses not to redeem the redeemable incentives the control passes to step 236 and the process ends.

The embodiments described herein are examples of compositions, structures, systems and methods having elements corresponding to the elements of the invention recited in the claims. This written description may enable those of ordinary skill in the art to make and use embodiments having alternative elements that likewise correspond to the elements of the invention recited in the claims. The scope of the invention thus includes compositions, structures, systems and methods that do not differ from the literal language of the claims, and further includes other structures, systems and methods with insubstantial differences from the literal language of the claims. While only certain features and embodiments have been illustrated and described herein, many modifications and changes may occur to one of ordinary skill in the relevant art. The appended claims cover all such modifications and changes.

What is claimed is:

1. A system comprising:
at least one e-commerce server;
at least one social network server; and
an interactive content server capable of collecting data from said e-commerce server,
creating at least one interactive content using said collected data, and sending said interactive content to said social network server.

2. The system of claim 1 further comprising at least one database having information related to goods available for purchase via said e-commerce server.

3. The system of claim 2, wherein said e-commerce server, said interactive content server, said social network server and said database communicate via a network.

4. The system of claim 2, wherein data collected by said interactive content server is combined with information available in said database to create said interactive content.

5. The system of claim 1, wherein said collected data is about goods on offer for purchase via said e-commerce server.

6. The system of claim 4, wherein said interactive content server sends said interactive content to said social network server via an Application Programming Interface (API).

7. The system of claim 6, wherein said social network server monitors interaction of a user with said interactive content and registers one or more redeemable incentives earned by said user upon successful interaction with said interactive content.

8. The system of claim 7, wherein said social network server sends information about redeemable incentives to said e-commerce server.

9. A method comprising steps of:
receiving a request for an electronic commerce application at an e-commerce server;
presenting said electronic commerce application comprising information about one or more goods available for purchase;
collecting data from at least one of said e-commerce server and a database;
creating at least one interactive content based on collected data;
sending said interactive content to a social network server; and
engaging an automated interaction between said social network server and said e-commerce server.

10. The method of claim 9, wherein the automated interaction comprises steps of:
publishing said interactive content on an online social network;
rewarding a user with redeemable incentives upon successful interaction of said user with said interactive content on said online social network; and
redeeming said redeemable incentives in response to said user purchasing goods from said electronic commerce application.

11. The method of claim 9, wherein said collected data is about goods on offer for purchase via said e-commerce server.

12. The method of claim 9, wherein said database contains information related to goods available for purchase via said e-commerce server.

13. The method of claim 12, wherein data collected by said interactive content server is combined with information available in said database to create said interactive content.

14. A method comprising steps of:
providing an e-commerce server, an interactive content server, and a social network server;
collecting data about goods purchased from an electronic commerce application hosted on said e-commerce server;
creating at least one interactive content based on said data about goods purchased using a computer executable algorithm on said interactive content server;
publishing said interactive content on an online social network hosted on said social network server;
rewarding a user with redeemable incentives when said user successfully interacts with said interactive content on said online social network; and
redeeming said redeemable incentives when said user purchases goods from said e-commerce application.

15. The method of claim 14 further comprising steps of:
receiving a request for an electronic commerce application at said e-commerce server; and
presenting said electronic commerce application, comprising information about one or more goods available for purchase at said electronic commerce server.

16. The method of claim 14, wherein at least one database comprises information related to goods available for purchase via said e-commerce server.

17. The method of claim 16, wherein data collected by the interactive content server is combined with information available in said database to create said interactive content.
